(19) United States
(12) Patent Application Publication
(10) Pub. No.: US 2006/0294096 A1
(43) Pub. Date: Dec. 28, 2006

(54) Additive clustering of images into events using capture date-time information

(75) Inventors: Bryan D. Kraus, Rochester, NY (US); Madirakshi Das, Rochester, NY (US); Alexander C. Loui, Penfield, NY (US); Samuel M. Fryer, Fairport, NY (US)

Correspondence Address: Mark G. Bocchetti, Patent Legal Staff;Eastman Kodak Company, 434 State Street, Rochester, NY, 14650-2201, US

(73) Assignee: Eastman Kodak Company

(21) Appl. No.: 11/158,569

(22) Filed: Jun. 22, 2005

(51) Int. Cl. G06F 17/30

(52) U.S. Cl. 707/6

(57) ABSTRACT

Additional records are combined into a database of earlier-entered records clustered into existing events. A common chronology of a set of the existing events in the database and the additional records is determined based upon respective date-times of origination. Relative proportions of the earlier-entered and additional records in the database are ascertained. The following are identified in the chronology: existing events immediately preceding, concurrent with, and immediately succeeding additional records. When the relative proportions are beyond a predetermined reuse threshold, all of the records of the set and the additional records are reclustered into new events independent of the existing events. When the relative proportions are within the predetermined reuse threshold, only the identified records are reclustered with the additional records.

### FIELD OF THE INVENTION

The invention relates to digital image processing that automatically classifies images and more particularly relates to additive clustering of images using capture date-time information.

### BACKGROUND OF THE INVENTION

With the widespread use of digital consumer electronic capturing devices such as digital cameras and camera phones, the size of consumers' image collections continue to increase very rapidly. Automated image management and organization is critical for easy access, search, retrieval, and browsing of these large collections.

A method for automatically grouping images into events and sub-events is described in U.S. Pat. No. 6,606,411 B1, to Loui and Pavie (which is hereby incorporated herein by reference). Date-time information provided by digital camera capture metadata and block-level color histogram similarity are is used to determine events and sub-events. This method has the shortcoming that clustering very large image sets can take a substantial amount of time. It is especially problematic if events and sub-events need to be recomputed each time new images are added to a consumer's image collection, since additions occur a few at a time, but relatively often. Another problem is that consumers need to be able to merge collections of images distributed across multiple personal computers, mobile devices, image appliances, network servers, and online repositories to allow seamless access. Recomputing events and subevents after each merger is inefficient.

It would thus be desirable to provide methods and systems, in which new images are additively clustered in a database using date-time information, without undue reclustering of the entire database.

### SUMMARY OF THE INVENTION

The invention is defined by the claims. The invention, in broader aspects, provides a method, computer program, and system, in which additional records are combined into a database of earlier-entered records clustered into existing events. A common chronology of a set of the existing events in the database and the additional records is determined based upon respective date-times of origination, such as capture dates of images. Relative proportions of the earlier-entered records and additional records in the database are ascertained. The following are identified in the chronology: existing events immediately preceding an additional record, existing events concurrent with one or more additional records, and existing events immediately succeeding additional records. When the relative proportions are beyond a predetermined reuse threshold, all of the records of the set and the additional records are reclustered into new events independent of the existing events. When the relative proportions are within the predetermined reuse threshold, only the identified records are reclustered with the additional records.

It is an advantageous effect of the invention that an improved methods and systems are provided, in which new images are additively clustered in a database using date-time information, without undue reclustering of the entire database.

### BRIEF DESCRIPTION OF THE DRAWINGS

The above-mentioned and other features and objects of this invention and the manner of attaining them will become more apparent and the invention itself will be better understood by reference to the following description of an embodiment of the invention taken in conjunction with the accompanying figures wherein:

FIG. 1 is a flowchart showing features of the method.

FIG. 2 is a diagrammatical view of an embodiment of the system.

FIG. 3 is a diagrammatical view of the operation of an embodiment of the method of FIG. 1, in adding additional records to a database. The number of additional records is beyond a reuse threshold. Event breaks are indicated by dashed lines. Boxes above the base line indicate events. Boxes below the base line indicate additional images. Existing events are cross-hatched.

FIG. 4 is the same view as FIG. 3, but the operation of the method is shown for a number of additional records within the reuse threshold. Cross-hatching indicates events excluded from reclustering. Existing events are cross-hatched.

FIG. 5 is the same view as FIG. 4, but shows the operation of an alternative embodiment of the method. The number of additional records is within a reuse threshold. Existing events are cross-hatched.

FIG. 6 is a flow chart showing division of a revised event of the method of FIG. 5. The records of the revised event are images.

### DETAILED DESCRIPTION OF THE INVENTION

In the method, images or other records are added to a database of records clustered into existing events. The events are organized based on date-time information associated with the records. The additional records are reclustered with some or all of the existing events depending upon the relative proportions of earlier-entered records and additional records. The method reduces the processing burden of reclustering, when small numbers of records are added, while still providing full reclustering when larger numbers of records are added. This approach also reclusters new records with records of temporally overlapping and temporally adjoining events whatever the number of new records added. This helps ensure that event continuity is maintained in the case that the new input records are part of the last event.

The term “date-time” is used herein to refer to time information. The date-time has a level of accuracy sufficient for a user's purposes in organizing images or other records. For example, digital cameras typically provide metadata with captured images that provides a date (including the year, month, and date) and a time in hours, seconds, and commonly decimal portions of a second. This metadata provides a convenient date-time, but other measures can be used. For example, elapsed time relative to a common standard can be used.

In the following description, some embodiments of the present invention will be described in terms that would ordinarily be implemented as software programs. Those skilled in the art will readily recognize that the equivalent of such software may also be constructed in hardware. Because image manipulation algorithms and systems are well known, the present description will be directed in particular to algorithms and systems forming part of, or cooperating more directly with, the method in accordance with the present invention. Other aspects of such algorithms and systems, and hardware and/or software for producing and otherwise processing the image signals involved therewith, not specifically shown or described herein may be selected from such systems, algorithms, components, and elements known in the art. Given the system as described according to the invention in the following, software not specifically shown, suggested, or described herein that is useful for implementation of the invention is conventional and within the ordinary skill in such arts.

As used herein, the computer program may be stored in a computer readable storage medium, which may comprise, for example; magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program.

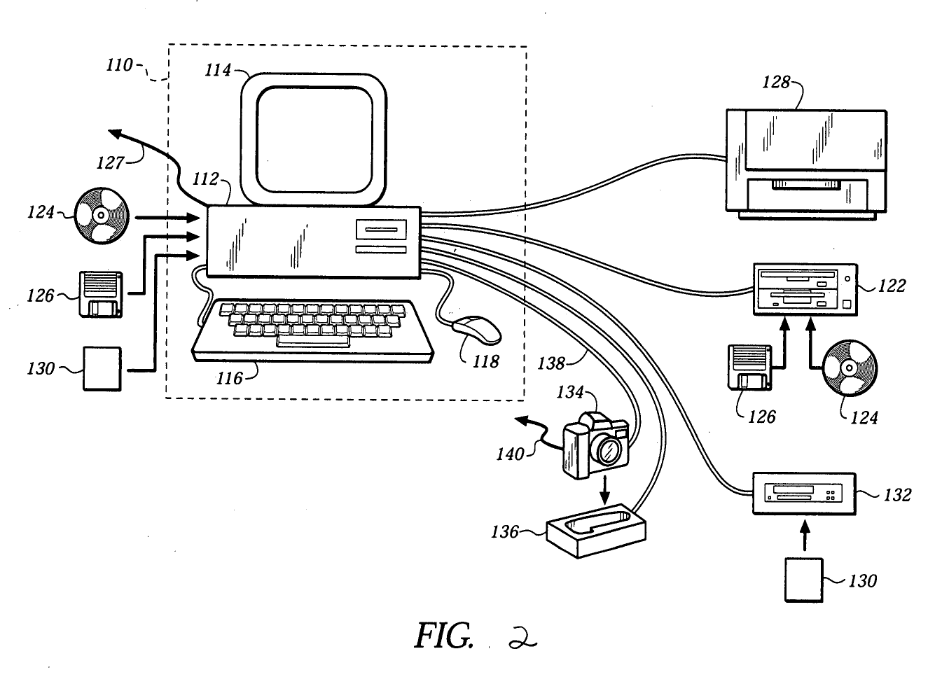

The present invention may be implemented in computer hardware. Referring to FIG. 2, there is illustrated a system for implementing the present invention. Although the computer system is shown for the purpose of illustrating a preferred embodiment, the present invention is not limited to the system shown, but may be used on any electronic processing system such as found in personal computers and other systems for the processing of digital images. Consequently, the computer system will not be discussed in detail herein. The images used herein can be directly input into the computer system (for example by a digital camera) or digitized before input into the computer system (for example by scanning originals, such as silver halide films).

Referring to FIG. 2, the computer system 110 includes a microprocessor-based unit 112 for receiving and processing software programs and for performing other processing functions. A display 114 is electrically connected to the microprocessor-based unit 112 for displaying user-related information associated with the software, e.g., by means of a graphical user interface. A keyboard 116 is also connected to the microprocessor based unit 112 for permitting a user to input information to the software. As an alternative to using the keyboard 116 for input, a mouse 118 may be used for moving a selector 120 on the display 114 and for selecting an item on which the selector 120 overlays, as is well known in the art.

A compact disk-read only memory (CD-ROM) 124, which typically includes software programs, is inserted into the microprocessor based unit for providing a means of inputting the software programs and other information to the microprocessor based unit 112. In addition, a floppy disk 126 can also include a software program, and is inserted into the microprocessor-based unit 112 for inputting the software program. The compact disk-read only memory (CD-ROM) 124 or the floppy disk 126 may alternatively be inserted into externally located disk drive unit 122, which is connected to the microprocessor-based unit 112. Still further, the microprocessor-based unit 112 may be programmed, as is well known in the art, for storing the software program internally. The microprocessor-based unit 112 may also have a network connection 127, such as a telephone line, to an external network, such as a local area network or the Internet. A printer 128 may also be connected to the microprocessor-based unit 112 for printing a hardcopy of the output from the computer system 110.

Images may also be displayed on the display 114 via a personal computer card (PC card) 130, such as, as it was formerly known, a PCMCIA card (based on the specifications of the Personal Computer Memory Card International Association), which contains digitized images electronically embodied in the card 130. The PC card 130 is ultimately inserted into the microprocessor-based unit 112 for permitting visual display of the image on the display 114. Alternatively, the PC card 130 can be inserted into an externally located PC card reader 132 connected to the microprocessor-based unit 112. Images may also be input via the compact disk 124, the floppy disk 126, or the network connection 127. Any images stored in the PC card 130, the floppy disk 126 or the compact disk 124, or input through the network connection 127, may have been obtained from a variety of sources, such as a digital camera (not shown) or a scanner (not shown). Images may also be input directly from a digital camera 134 via a camera docking port 136 connected to the microprocessor-based unit 112 or directly from the digital camera 134 via a cable connection to the microprocessor-based unit 112 or via a wireless connection 140 to the microprocessor-based unit 112.

The output device provides a final image that has been subject to the transformations. The output device can be a printer or other output device that provides a paper or other hard copy final image. The output device can also provide the final image as a digital file. The output device can also includes combinations of output, such as a printed image and a digital file on a memory unit, such as a CD or DVD.

The present invention can be used with multiple capture devices that produce digital images. For example, FIG. 2 can represent a system, in which one of the image-capture devices is a conventional photographic film camera for capturing a scene on color negative or reversal film and a film scanner device for scanning the developed image on the film and producing a digital image. Another capture device can be a digital radiography capture unit (not shown) having an electronic imager. The electronic capture unit can have an analog-to-digital converter/amplifier that receives the signal from the electronic imager, amplifies and converts the signal to digital form, and transmits the image signal to the microprocessor-based unit.

The microprocessor-based unit 112 provides the means for processing the digital images to produce pleasing looking images on the intended output device or media. The present invention can be used with a variety of output devices that can include, but are not limited to, a digital photographic printer and soft copy display. The microprocessor-based unit 112 can be used to process digital images to make adjustments for overall brightness, tone scale, image structure, etc. of digital images in a manner such that a useful image is produced by an image output device. Those skilled in the art will recognize that the present invention is not limited to just these mentioned image processing functions.

The general control computer shown in FIG. 2 can store the present invention as a computer program product having a program stored in a computer readable storage medium, which may include, for example: magnetic storage media such as a magnetic disk (such as a floppy disk) or magnetic tape; optical storage media such as an optical disc, optical tape, or machine readable bar code; solid state electronic storage devices such as random access memory (RAM), or read only memory (ROM). The associated computer program implementation of the present invention may also be stored on any other physical device or medium employed to store a computer program indicated by offline memory device. Before describing the present invention, it facilitates understanding to note that the present invention is preferably utilized on any well-known computer system, such as a personal computer.

It should also be noted that the present invention can be implemented in a combination of software and/or hardware and is not limited to devices that are physically connected and/or located within the same physical location. One or more of the devices illustrated in FIG. 2 can be located remotely and can be connected via a network. One or more of the devices can be connected wirelessly, such as by a radio-frequency link, either directly or via a network.

The present invention may be employed in a variety of contexts and environments. Exemplary contexts and environments particularly relevant to combining images from different modalities include, without limitation, medical imaging, remote sensing, and security imaging related to transport of persons and goods. Other exemplary contexts and environments particularly relevant to modalities capturing visible light include, without limitation, wholesale digital photofinishing (which involves exemplary process steps or stages such as film or digital images in, digital processing, prints out), retail digital photofinishing (film or digital images in, digital processing, prints out), home printing (home scanned film or digital images in, digital processing, prints out), desktop software (software that applies algorithms to digital images), other digital fulfillment (such as digital images in—from media or over the web, digital processing, with images out—in digital form on media, digital form over the web, or printed on hard-copy prints), kiosks (digital or scanned input, digital processing, digital or scanned output), mobile devices (e.g., PDA or cell phone that can be used as a processing unit, a display unit, or a unit to give processing instructions), and as a service offered via the World Wide Web.

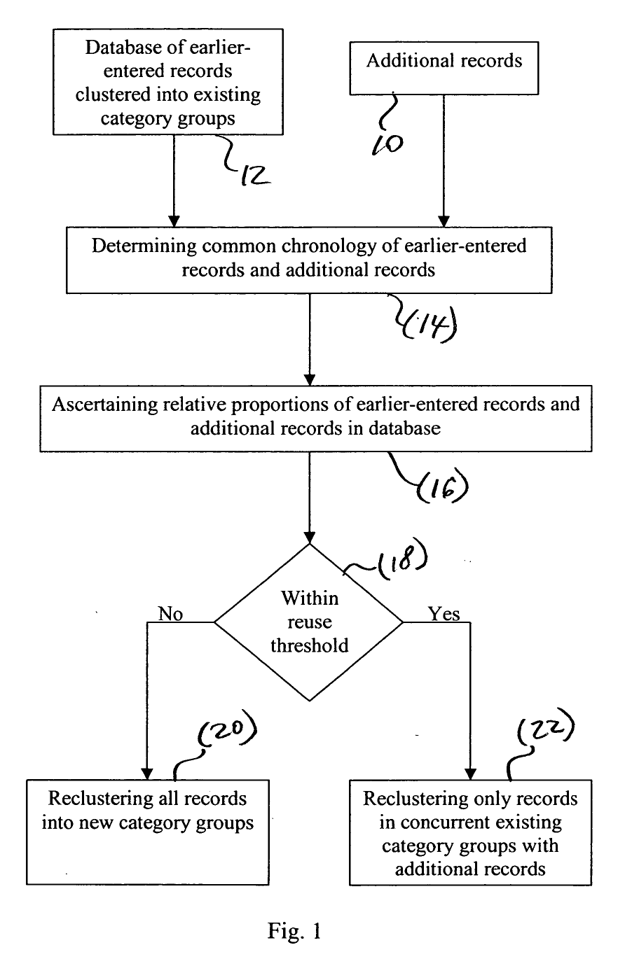

Referring now to FIG. 1, the method is directed to adding additional records 10 to a database 12 of earlier-entered records clustered into existing events. A common chronology is determined (14) for the additional records 10 and a set of the earlier-entered records. The chronology is based upon date-times of origination of the respective records. The relative proportions of the earlier-entered records and additional records in the database are determined (16) and compared (18) to a predetermined reuse threshold. When the relative proportions are beyond a predetermined reuse threshold, all of the records of the set and the additional records are reclustered (20) into new events independent of the existing events. When the relative proportions are within the predetermined reuse threshold, the additional records are reclustered (22) only with earlier-entered records of existing events concurrent with and/or next to one or more of the additional records in the chronology.

The date-times of origination of records have sufficient precision to allow sequencing in the chronology in a manner that provides value to the user. This precision can be uniform or can vary within a single database. For example, a user can manually assign years of capture to scans of old photographic prints, to organize the old photos in the same database with new digital images having automatically dates and times of capture.

A date-time of origination relates to the creation of content within a record and not simply to transfer or copying of information. Thus, the date-time of entry of a file in memory or in a particular database, while useful for some purposes, is not a date-time of origination. With images and audio, origination is capture or other creation. Date-times of origination of other kinds of records are comparable.

In the method, new records 10 are added to a database 12 of records clustered into existing events. The records are digital files that can be sorted in a meaningful way using respective dates of origination of the files or the underlying content of the files. Examples of such files are images, audio files, and journal entries. (The term “images” is used here in a broad sense inclusive of image sequences.) The new images can come from one source or multiple sources. For example, the new images can be from a digital camera, on a PictureCD obtained by scanning film negatives during photofinishing, or image files on portable media or obtained via a network.

The term “database” is used here to refer to a collection of related digital files that are accessed using management software, which in combination with a computer operating system and appropriate equipment provides some or all of the functions: file organization, storage, retrieval, security, and integrity. The database, at the time of addition of the new records, has previously entered records organized into clusters defining events. (The term “existing events” is used to differentiate events that were previously determined from later determined events.) The earlier-entered records can have been entered into the database all at once or piecemeal. At the time of addition of the new records, the database has the earlier-entered records organized by event and, optionally, by subevent. It is highly preferred that the database have sufficient integrity that the events of the database represent the products of a clustering procedure using the records present in the database. In other words, it is highly preferred that the database not be clustered and then be subject to additions and/or removals of records without use of a clustering procedure. This integrity can be provided by deterring or preventing additions and/or removals of records independent of management software that requires use of a clustering procedure.

The records of the database and the additional records all have an associated date-time of origination. This information is of value to the user in the organization and use of the records of the database, for example, records are dated journal entries or captured images. The date-time of origination is associated with a particular record when the record is entered in the database or is assigned to a particular record when the record is entered or afterwards. For example, date-time of origination can commonly be extracted from metadata associated with digital images. If the date-time is assigned, then the assignment is overseen (made or reviewed) by the user. Accurate assignment of date-times is important to the accuracy of the resulting organization of the database. A portion of the records in a database that are assigned arbitrary “date-times of origination”, such as date-times of entry into the database, rather than actual date-times of origination, tends to degrade the quality of the organization of the database proportional to its relative size in the database.

The common chronology of the earlier-entered records and additional records is a logical arrangement of those records into a single time sequence. This chronology is made available, in some form, to the user following reclustering. For example, a time line can be presented on a display. The chronology is determined before reclustering.

The reclustering (and earlier clustering) of the database is not limited to any particular clustering technique. Since reclustering can be repeated multiple times, use of manual reclustering presents a large risk of unacceptable variability. The risk is less if manual clustering is limited to the initial clustering. With automatic clustering, it is preferred that the clustering and reclustering of a database be limited to the same technique to prevent a risk of anomalous results due to the change in techniques rather than actual differences in records.

Examples of types of clustering techniques include: k-means clustering and hierarchical clustering. An example of a convenient clustering technique is disclosed in U.S. Pat. No. 6,606,411. The clustering is described for pictures having date-time information. First, time intervals between adjacent pictures (time differences) are computed. A histogram of the time differences vs. number of pictures is then prepared. If desired, the histogram can then be then mapped to a scaled histogram using a time difference scaling function. This mapping substantially maintains small time differences and compresses large time differences. A two-means clustering is then performed on the mapped time-difference histogram for separating the mapped histogram into two clusters based on the time difference. Normally, events are separated by large time differences. The cluster having larger time differences is considered to represent time differences that correspond to the boundaries between events.

In a particular embodiment of the method, a new time difference threshold is calculated during reclustering of all of the records and a predetermined time difference threshold is used during reclustering limited to earlier entered records of concurrent and adjoining events. This reduces computation time. The predetermined time difference threshold is from an earlier clustering or reclustering. It is preferred that the time difference threshold is stored in memory following each clustering to be ready for use in the subsequent reclustering, if the subsequent reclustering is limited to earlier entered records of concurrent and adjoining events. As an alternative, storage can be limited to the predetermined time difference threshold and time differences for earlier-entered records. As another alternative, the time difference histogram is stored in memory following clustering or reclustering. In subsequent reclustering the time difference histogram is then supplemented with the time differences from the additional records and used to calculate an updated time difference threshold. This provides an updated time difference threshold while reducing computation time by avoiding recalculation of the time difference histogram.

The reuse threshold determines whether some or all of the earlier-entered records are included in the reclustering. All of the records are utilized, if the relative proportions of additional records and earlier-entered records are beyond the reuse threshold. In that case, the reclustering is independent of the existing events. The result of the reclustering is revised events, which completely replace the existing events.

Only the earlier-entered records are used, if the relative proportions of additional records and earlier-entered records are within the reuse threshold. In that case, the reclustering utilizes the time difference threshold that had been determined in the earlier clustering of the existing events. This reclustering retains existing events that are not concurrent with or next to additional records in the common chronology and moves into revised events the additional records and the records of concurrent and adjoining events. The revised events replace only existing events that were concurrent or next to the additional records.

The relative proportions of the earlier-entered records and the additional records are ascertained and a comparison is made to a predetermined reuse threshold. The relative proportions can be based upon counts or estimates. For example, totals of file size can be compared. Selection of counts or particular estimates is a matter of convenience and efficiency and the precision needed for comparison to a particular reuse threshold.

The mathematics of comparing the relative proportions of the earlier-entered records and the additional records and then comparing that result to the reuse threshold, is a matter of convenience. For example, the percentage of additional records relative to a total of the earlier-entered records and the additional records can be calculated. This calculated percentage can then be compared to a predetermined reuse threshold provided as a like percentage. A calculated percentage at or smaller than the reuse threshold is within the reuse threshold. A larger calculated percentage is beyond the reuse threshold.

In a particular embodiment, the reuse threshold is selected such that, when the database size is much larger than the incoming set of additional records, the 2-means algorithm for clustering the time difference histogram uses the existing database record set, that is, only the earlier-entered records. The additional records are not used to recompute the time difference histogram. An example of such a reuse threshold is a ratio of one additional record to every four earlier-entered records. In that embodiment, when the earlier-entered records are comparable in number with the incoming record set, the clustering is recomputed with the combined time differences histogram from both the earlier-entered and additional records.

The reuse threshold can also be set adaptive to one or more characteristics of the additional records. Examples of such characteristics are date-times of origination of the additional records and image content of the additional records. In a particular embodiment, a reuse threshold of one additional record to every ten earlier-entered records is used when the additional records have a date-time of origination more than one year later than the earlier entered records. Otherwise, a reuse threshold of one additional record to every four earlier-entered records is used. In that embodiment, a smaller proportion of additional records is required to recompute the time difference histogram when the precomputed time difference histogram is out of date.

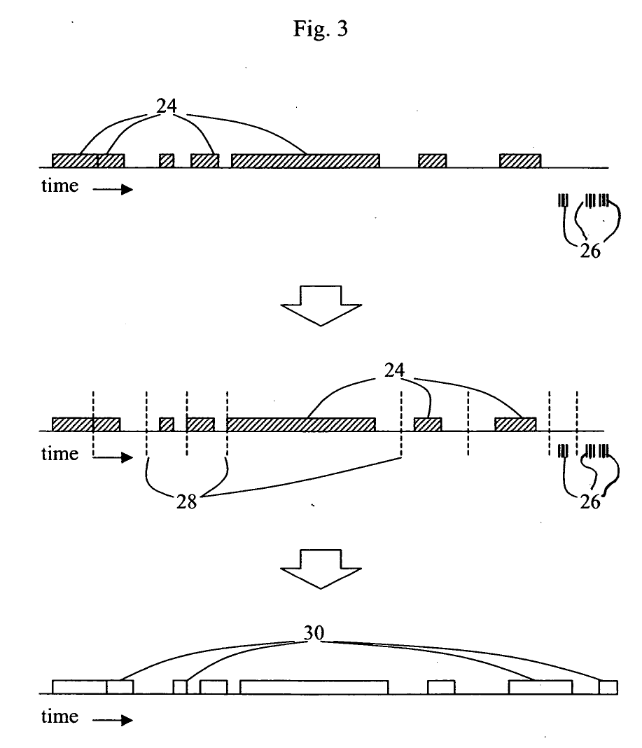

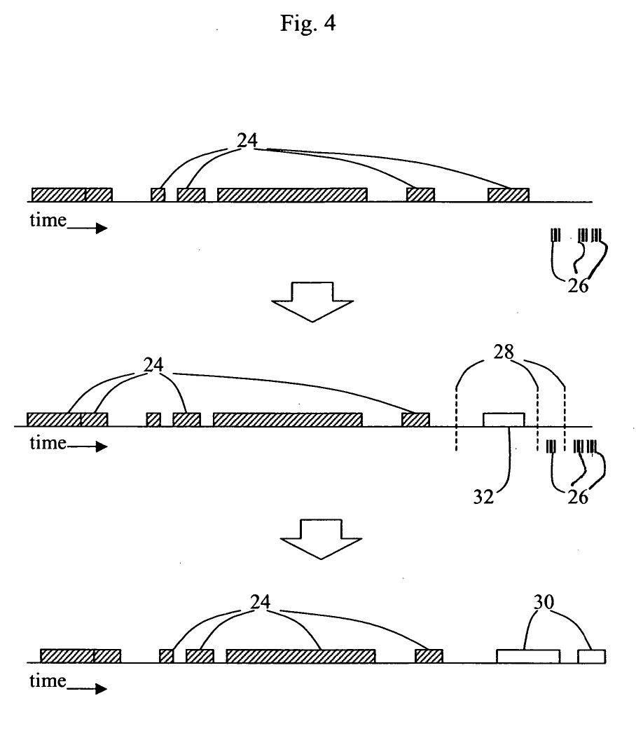

FIGS. 3-4 illustrate a records database and additional records 26, during the additive reclustering of the database. In FIG. 3, the number of additional records is beyond a reuse threshold. At a first stage, the database of earlier-entered records and additional records are combinable. (The existing events 24 of the earlier-entered records are shown along with the new records 26.) Referring to FIGS. 1 and 3, relative proportions are ascertained and compared to the reuse threshold. At a second stage, based upon that comparison, a combined histogram of time differences of all the records is calculated. A time difference threshold is determined and reclustering is performed. Breaks 28 are shown as dashed lines. In this embodiment, at a third stage, the resulting revised events 30 are compared across breaks and are combined if similar in content.

In FIG. 4, the number of additional records is within the same reuse threshold. The stages are the same, except that the reclustering is limited to earlier-entered records in identified events 32, which are existing events 24 that are concurrent with and/or immediately before/after one or more additional records. The additional records 26 are then reclustered with earlier-entered records of the identified event(s) 32 to provide revised events 30. This reclustering uses the predetermined time difference threshold and time differences for the additional records the earlier-entered records of the identified events. The database is revised to add the additional records and replace the identified events with the revised events. The remaining existing events are retained.

Events, optionally, can be divided into subevents following the subclustering. It is highly preferred that division into subevents following subclustering be limited to revised events. This prevents repetition with any existing events retained following the reclustering. For convenience, only division of revised events is discussed in the following.

The division of revised events can be based upon content of the respective records or associated metadata or a combination of both. For example, a revised event with many records can be divided based upon date-times. As another example, in embodiments in which all or most records are images (still images or video sequences), revised events can be subdivided based upon visual content analysis. In embodiments in which all or most records are video or audio clips, revised events can be subdivided based upon aural content analysis. As an option, event breaks adjoining revised events can also be verified by visual and/or aural content analysis.

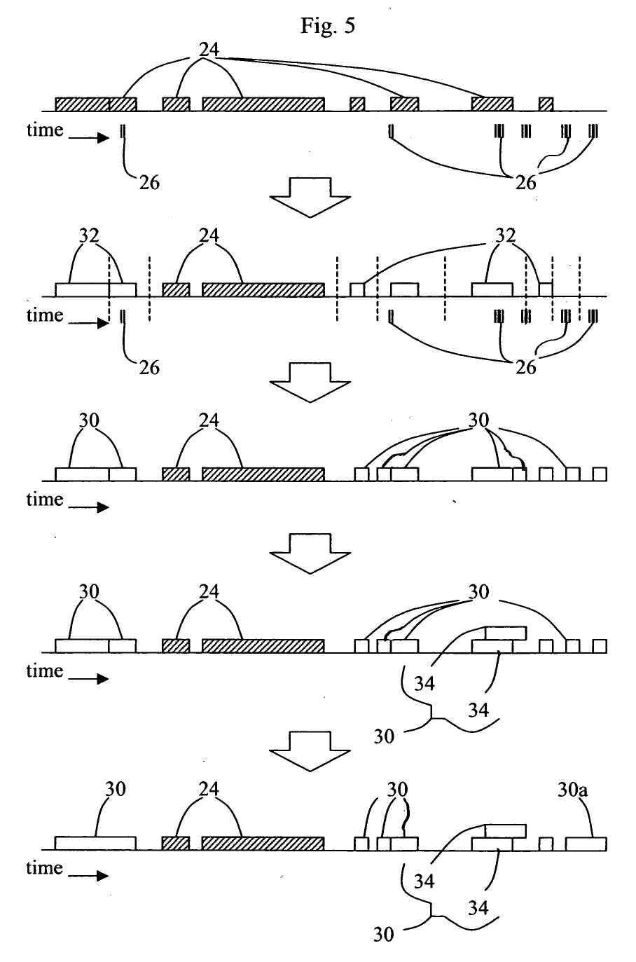

Subevents are ordinarily sequential within an event. Parallel subevents can be provided, by a division of records within a revised event into two or more parallel subevents, based upon a feature associated with origination of the records in parallel. Referring now to an example additive clustering shown in FIG. 5, the first three stages are the same as for the example shown in FIG. 4. The division of a revised event 30 into parallel subevents 34 occurs at a fourth stage.

An example of a feature usable for dividing a revised event into parallel events is metadata identifying several different cameras. This can be useful when images are captured at the same event, such as a wedding or party, by different people using different digital cameras. In this and other cases, the user can decide whether to place in parallel subevents, records that originated in parallel or to retain the records without such a division.

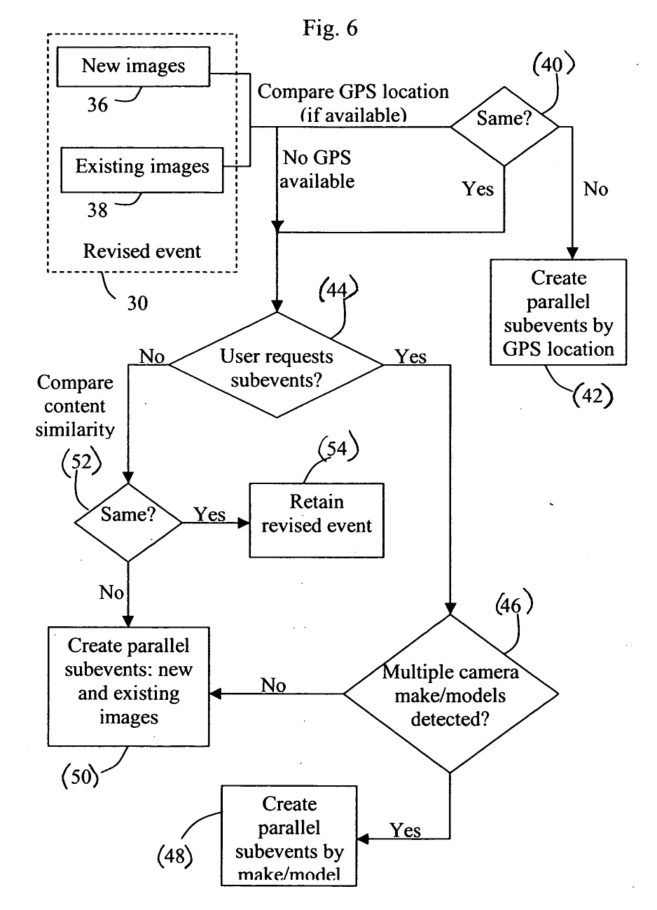

Parallel subevents can be identified by use of metadata or content that identifies a particular geographic location. For example, images or other records can incorporate GPS (Global Positioning System) or other geopositioning system data for the location of origination. Another approach is to allow the user to register each camera or other feature associated with origination of the records in parallel, with the database. For example, a user could input a list of cameras defined by a metadata feature, such as make, model, and identification number, and identify a status as combined or parallel for subevent images from each camera. This metadata can be used directly in the database or can be interpreted in accordance with rules entered by the user. For example, names of photographers can be associated with particular cameras. Similarly, different cameras can be associated with different geographic locations, such as “home” and camp The user can also be given control, at one or more points, over whether events are considered for treatment as parallel subevents. Parallel subevents tend to emphasize content while deemphasizing or obscuring chronology of image capture during events. Sequential subevents tend to do the opposite and, thus, are better for the use of images to tell a story. Referring now to FIG. 6, a revised event 30 has new (additional) images 36 and existing (earlier-entered) images 38. The images of the revised event are checked (40) for the presence of metadata indicating a GPS location. If the metadata shows different locations for the new and existing images, then a parallel subevent is created (42) for each GPS location. If there is no GPS metadata or the same location is indicated, then a check is made (44) as to whether the user has requested different parallel subevents be provided. If parallel subevents are requested, then the metadata is checked (46) for use of multiple cameras. If multiple, registered cameras were used, then the parallel subevents are created (48) based upon camera usage metadata. If multiple cameras are not detected and the user requested parallel subevents, then the revised event is divided (50) into parallel subevents of new images and existing images. If the user did not request parallel subevents, then the new and existing images are checked (52) for content similarity. If the new and existing images are similar, then the revised event is not divided (54). If the new and existing images are dissimilar, then the revised event is divided (50) into parallel subevents of new images and existing images. It will be apparent that the above example can be modified to replace and/or change the order of the various determinations, to provide sequential rather than parallel subevents for one or more of the determinations, and to eliminate user intervention or provide intervention at one or more different times in the same or a different manner.

In embodiments in which all or most records are images, event breaks adjoining revised events are, optionally, verified by image content analysis, and neighboring events are merged if they contain similar images. Images of a revised event that falls between two other events are first compared to images of the nearer of the two other events in terms of time difference. If the images are similar, the revised event and the nearer of the two other events are merged to provide a modified event. If the images of those two events are found to be different in content, then the images of the revised event are compared with the farther of the two other events; and if similar, those two events are merged to provide a modified event. If the images of the revised event are dissimilar from those of both of the other events, then the revised event is retained. Referring again to FIG. 5, in a fifth stage, two revised events 30 are combined into a modified revised event 30a.

The image content analysis used can be by a variety of comparison techniques and can be applied manually or automatically. In a particular embodiment, color matching based on histograms computed in each block of images divided into small blocks, as described in U.S. Pat. No. 6,351,556 to Loui and Pavie (which is hereby incorporated herein by reference), is used to compute similarity between images. This similarity measure has also been used to determine sub-event boundaries in the automatic event clustering method described in U.S. Pat. No. 6,606,411 B1, to Loui and Pavie. Alternatively, low-level features such as color, texture, and color composition can be used for computing similarity. Color and texture representations and a procedure for similarity-based retrieval is disclosed in U.S. Pat. No. 6,480,840, to Zhu and Mehrotra, issued on Nov. 12, 2002 (which is hereby incorporated herein by reference). In this patent, the dominant colors of an image are determined and each dominant color is described by attribute sets that include color range, moments and distribution within a segment. Texture is described in terms of contrast, scale, and angle. Similarity scores between two images are computed as a weighted combination of the similarity of the underlying features.

For efficiency, it is convenient to use the same image content analysis for both division of events into subevents and merging of similar events, but different image content analyses can be used. Likewise, for efficiency, it is convenient for the database to support content-based image retrieval using the same feature or features on which the similarity measure is based.

The additive clustering can save unnecessary effort and adjust performance by excluding some earlier-entered records from the additive clustering rather than using all of the earlier-entered records. This can be done by determining one or more property of the additional records and selecting a set of the earlier-entered records for use in the additive clustering responsive to those properties. The property or properties can be provided by one or more types of metadata or can be determined by analysis of record content or both. For example, the property can be a date-time range and the set can be limited to earlier-entered records in existing events inclusive of or close to the same date-time range. For example, a set can be limited to records after a particular date or in a particular month and year.

In a particular embodiment, the database tracks whether events have been reviewed by the user. Changes to events, except inclusion of additional records and subevents, is avoided if the respective events have been reviewed by the user. This ensures that the event boundaries earlier seen by the user are maintained. Since the user can label events during review, maintaining breaks as reviewed also preserves earlier efforts at labelling.

The invention has been described in detail with particular reference to certain preferred embodiments thereof, but it will be understood that variations and modifications can be effected within the spirit and scope of the invention.

1. A method for combining additional records into a database of earlier-entered records clustered into existing events, said method comprising the steps of:
determining a common chronology of a set of the existing events in the database and the additional records based upon respective date-times of origination;
identifying in said chronology, each of said existing events immediately preceding one of said additional records, each of said existing events concurrent with one or more of said additional records, and each of said existing events immediately succeeding one of said additional records to provide identified events;
ascertaining relative proportions of said earlier-entered records and said additional records in said database;
reclustering all of said records of said set and said additional records into new events independent of said existing events, when said relative proportions are beyond a predetermined reuse threshold; and
reclustering only said identified records with said additional records, when said relative proportions are within said predetermined reuse threshold.

2. The method of claim 1 wherein said reclustering with said additional records uses a predetermined time difference threshold based on all of said earlier entered records.

3. The method of claim 1 further comprising, prior to said reclustering steps, setting said reuse threshold adaptive to one or more characteristics of said additional records.

4. The method of claim 3 wherein said setting is adaptive to respective said date-times of origination of said additional records.

5. The method of claim 3 wherein said additional records are images and said setting is adaptive to image content of said additional records.

6. The method of claim 1 wherein said reclustering with said additional records provides revised events and further comprises:
revising said database to add said additional records and replace said identified events with said revised events; and
retaining remaining said existing events.

7. The method of claim 6 wherein said reclustering all of said records provides revised events and further comprises revising said database to add said additional records and replace all of said existing events with said revised events.

8. The method of claim 7 further comprising dividing at least one of said revised events into a plurality of subevents.

9. The method of claim 8 further comprising:
allowing user review of said revised events, and excluding from change, except inclusion of additional records and subevents, any of said revised events subject to said user review.

10. The method of claim 8 wherein at least two of said subevents are parallel in time.

11. The method of claim 8 wherein said dividing further comprises comparing one or more of: metadata associated with and content similarity of respective said records of said revised events.

12. The method of claim 6 further comprising dividing at least one of said revised events into a plurality of subevents.

13. The method of claim 1 further comprising:
determining one or more properties of said additional records; and
selecting said set of earlier-entered records responsive to said one or more properties.

14. The method of claim 13 wherein said additional records each include one or more new images and said determining further comprises analyzing said new images.

15. The method of claim 13 wherein said one or more properties include a date-time range and said set is limited to earlier-entered records in existing events inclusive of said date-time range.

16. The method of claim 12 wherein said one or more properties includes a range of said date-times and said set excludes earlier-entered records having respective date-times older than said range by more than a predetermined period.

17. The method of claim 1 wherein said set is all of said earlier-entered records.

18. The method of claim 1 wherein said reuse threshold is a ratio of in excess of one of said additional records to every four of said earlier-entered records.

19. The method of claim 1 further comprising, following said reclustering steps:
receiving more additional records; and
repeating said determining, identifying, ascertaining, and both reclustering steps.

20. A computer program product for combining additional records into a database of earlier-entered records clustered into existing events, the computer program product comprising computer readable storage medium having a computer program stored thereon for performing the steps of:
determining a common chronology of a set of the existing events in the database and the additional records based upon respective date-times of origination;
identifying in said chronology, each of said existing events immediately preceding one of said additional records, each of said existing events concurrent with one or more of said additional records, and each of said existing events immediately succeeding one of said additional records to provide identified events;
ascertaining relative proportions of said earlier-entered records and said additional records in said database;
reclustering all of said records of said set and said additional records into new events independent of said existing events, when said relative proportions are beyond a predetermined reuse threshold; and
reclustering only said identified records with said additional records, when said relative proportions are within said predetermined reuse threshold.

21. A system for combining additional records into a database of earlier-entered records clustered into existing events, said method comprising:
means for determining a common chronology of said earlier-entered records and said additional records based upon respective date-times of origination;
means for identifying in said chronology, each of said existing events immediately preceding one of said additional records, each of said existing events concurrent with one or more of said additional records, and each of said existing events immediately succeeding one of said additional records to provide identified events;
means for ascertaining relative proportions of said earlier-entered records and said additional records in said database;
means for reclustering all of said records into new events independent of said existing events, when said relative proportions are beyond a predetermined reuse threshold; and
means for reclustering said additional records with respective said earlier-entered records of said identified events and retaining remaining said existing events, when said relative proportions are within said predetermined reuse threshold.

22. A method for combining additional records into a database of earlier-entered records clustered into existing events, said method comprising the steps of:
determining a common chronology of said earlier-entered and additional records based upon respective date-times of origination;
ascertaining relative proportions of said earlier-entered records and said additional records in said database;
when said relative proportions are beyond a predetermined reuse threshold, reclustering all of said records into new events independent of said existing events to provide revised events, said revised events replacing said existing events; and
when said relative proportions are within said predetermined reuse threshold, reclustering with said additional records only ones of said earlier-entered records in existing events concurrent with or next to said additional records in said chronology to provide revised events, said revised events replacing only said existing events concurrent with or next to said additional records in said chronology.

23. The method of claim 22 wherein a plurality of said records are images and said date-times of origination are date-times of capture.

24. The method of claim 23 further comprising, prior to said reclustering steps, setting said reuse threshold adaptive to one or more characteristics of said additional records.

25. The method of claim 24 wherein said setting is adaptive to respective said date-times of said additional records.

26. The method of claim 23 wherein said additional records are images and said setting is adaptive to image content of said additional records.

27. The method of claim 23 further comprising dividing at least one of said revised events into a plurality of subevents.

28. The method of claim 27 wherein at least two of said subevents are parallel in time.

29. The method of claim 27 wherein said dividing further comprises comparing one or more of: metadata associated with respective said images of said revised events and content similarity of respective said images of said revised events.

30. The method of claim 23 wherein one or more of said additional records and one or more of said earlier-entered records are image sequences.

31. The method of claim 22 further comprising:
determining one or more properties of said additional records; and
selecting said set of earlier-entered records responsive to said one or more properties.

32. The method of claim 31 wherein said determining said one or more properties further comprises reading metadata associated with respective said records.

33. The method of claim 31 wherein said additional records each include one or more images and said determining further comprises analyzing said images.
